(19) United States
(12) Patent Application Publication
(10) Pub. No.: US 2006/0186098 A1
(43) Pub. Date: Aug. 24, 2006

(54) Method and apparatus for laser processing

(76) Inventor: Charles L. Caristan, Houston, TX (US)

Correspondence Address: Linda K. Russell;Air Liquide, Suite 1800, 2700 Post Oak Blvd., Houston, TX, 77056, US

(21) Appl. No.: 11/338,271

(22) Filed: Jan. 24, 2006

Related U.S. Application Data
(60) Provisional application No. 60/655,671, filed on Feb. 23, 2005.

(51) Int. Cl. B23K 26/06

(52) U.S. Cl. 219/121.74

(57) ABSTRACT

Apparatus and method for focusing a laser. Embodiments of the invention provide a multiple focal mirror device having at least a first reflective surface and a second reflective surface and a light condensing device. An incident laser beam is reflected from each of the reflective surfaces to produce resultant, respective partial laser beams. The partial laser beams are directed to the light condensing device which operates to focus the partial laser beams according to respective focal points of the partial laser beams, the focal points being different from each other.

### CROSS-REFERENCE TO RELATED APPLICATIONS

This application claims the benefit of U.S. Provisional Application No. 60/655,671, filed Feb. 23, 2005, the entire contents of which are incorporated herein by reference.

### BACKGROUND

In commercial fabrication, laser dual focus lenses are used to enhance processing speed. Enhanced processing speed is achieved in that dual focus lenses allow a laser beam to be focused at more than one focal point. U.S. Pat. No. 6,521,864 discloses such a multiple focus laser beam system, and is herein incorporated by reference.

Just as with standard focusing lenses, dual focus lenses may be manufactured of some base material (such as ZnSe or quartz, depending on the application in which the lens is to be used) and then coated with anti-reflective layers. These layers have a low absorption coefficient to the wavelength of the laser beam radiation; however, the absorption is not totally null. The small absorption coefficient becomes a challenge when the laser power density incident on the focusing lens increases, with either standard focusing lenses or dual-focus lenses. This is the case, for example, with increasingly high power lasers being used for industrial processing of metal sheets and plates. While absorbing some laser power, focusing lenses reduce the power impinging the work piece, reduce the life expectancy of the focusing lens in use before cleaning or replacement, and can create thermal lensing problems contributing to degradation of repeatability and reproducibility of laser processing performances.

For the foregoing reasons, there is a need in the industry for an improved or alternative method and apparatus for the multiple focusing of a laser beam.

### SUMMARY

In one aspect of the present invention, an apparatus for focusing a laser beam is provided. The apparatus of the present invention includes a multiple focal mirror device, comprising at least a first reflective surface and a second reflective surface, for reflecting an incident laser beam respectively from each of said reflective surfaces so as to be decomposable into a plurality of partial laser beams, and a light condensing device, such as, for example, a standard focusing lens, to which the partial laser beams are directed from said multiple focal mirror device, for respectively focusing the partial laser beams such that positions of maximally focal points of the partial laser beams are different from each other.

Another aspect of the present invention includes at least one laser generator for generating at least one laser beam; at least one cutting nozzle with at least one laser beam inlet and at least one laser beam outlet; a multiple focal mirror device, comprising at least a first reflective surface and a second reflective surface, for reflecting said laser beam respectively from each of said reflective surfaces as a plurality of partial laser beams; and a light condensing device, to which the partial laser beams are directed from said multiple focal mirror device, for respectively focusing the partial laser beams such that positions of maximally focal points of the partial laser beams are different from each other, said focused partial laser beams being directed to said cutting nozzle.

Another aspect of the present invention includes introducing at least one incident laser beam; directing said incident laser beam toward a multiple focal mirror device, said multiple focal mirror device comprising at least a first reflective surface and a second reflective surface; splitting said incident laser beam into at least a first reflected laser beam and a second reflected laser beam; wherein said first reflected laser beam is the result of the incident laser beam striking and reflecting off of said first reflective surface, and wherein said first reflected laser beam has a first point of focus, said second reflected laser beam is the result of the incident laser beam striking and reflecting off of said second reflective surface, and wherein said second reflected laser beam has a second point of focus; said first point of focus and said second point of focus having a different plane of focus, and directing said first reflected beam and said second reflected beam through a refractive lens; wherein through said refractive lens, said first reflected laser beam has a third point of focus, said second reflected laser beam has a fourth point of focus, and said third point of focus and said fourth point of focus having a different plain of focus.

Another aspect of the present invention consists of introducing at least one incident laser beam; directing said incident laser beam toward a multiple focal mirror device, said multiple focal mirror device comprising at least a first reflective surface and a second reflective surface; splitting said incident laser beam into a plurality of partial laser beams; and directing said partial laser beams through a refractive lens, wherein said partial laser beams have a different plane of focus.

Without limitation, the present invention may be used for laser cutting, laser welding, laser drilling, laser marking, laser brazing, and laser surface treatment. The present invention may be used with the addition of powder, without the addition of powder, with the addition of filler material, or without the addition of filler material. The present invention may be used with any combination of shielding gas, with any combination of assist gas, without any shield gas, or without any assist gas. The present invention may utilize an incident laser beam that is generated by a laser selected from the group consisting of CO₂ laser, YAG laser, fiber laser, disk laser, diode laser or any kind of industrial laser used directly or in combination with other heat sources, such as an arc welding torch for hybrid laser processing.

### BRIEF DESCRIPTION OF THE DRAWINGS

The invention may be understood by reference to the following description taken in conjunction with the accompanying drawings, and in which:

FIG. 1 illustrates a schematic representation of a multiple focus laser device, shown without the effects of the light condensing device, in accordance with one illustrative embodiment of the present invention;

FIG. 2 illustrates a schematic representation of a multiple focus laser device, shown with the effects of the light condensing device, in accordance with one illustrative embodiment of the present invention;

FIG. 3 illustrates a schematic representation of another multiple focus laser device, shown without the effects of the light condensing device, in accordance with one illustrative embodiment of the present invention; and

FIG. 4 illustrates a schematic representation of another multiple focus laser device, shown with the effects of the light condensing device, in accordance with one illustrative embodiment of the present invention.

It is to be noted, however, that the appended drawings illustrate only typical embodiments of this invention and are therefore not to be considered limiting of its scope, for the invention may admit other equally effective embodiments.

### DETAILED DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Furthermore, in various embodiments the invention may provide numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

This invention relates to a method and apparatus for laser processing, using a combination of transmissive, and/or reflective optics to focus the incident laser beam or laser beams, such as to obtain more than one plane of focus. The invention can be applied in all laser processing applications, and in particular, to laser cutting, laser welding and laser surface treatment with or without powder or filler material addition, and with or without any combination of assist gas and shielding gas. The laser used can be any combination of one or more of the industrial laser resonators types used for material processing, such as CO₂ lasers, YAG lasers, Fiber lasers, Disk lasers, and other lasers.

One embodiment of the present invention provides a solution for laser processing at high power while using a set of optics that generate more than one focus point in order to continue to benefit from multi-focus technology at increasingly high power. In particular, it consists of laser processing by focusing the laser beam with a combination of transmissive optics and reflective optics, such as to enable high power processing with a high degree of performance repeatability and reproducibility.

Compared to transmissive optics (lenses), reflective optics (mirrors) can sustain extremely high laser power without suffering the same degree of thermal lensing. Some CO₂ lasers operate reliably with mirrors at 45 kW of unfocused power, whereas with lenses, even when unfocused, 4 to 6 kW of power are approaching the boundary of sustainability. Also, in operation, a mirror generally has a much higher life than a lens, and therefore, the dual focus mirror does not need replacement and cleaning as frequently as a dual focus lens.

The present invention is directed to a method and apparatus for laser processing while using dual-focus or multiple focus optics combinations to focus incident laser beam(s) on the work piece, such as to form more than one focus point of extreme power density at the work piece. In the case of a CO₂ laser cutting application, such a set can be composed of a combination of a standard focusing lens with a multi-focus mirror located upstream or downstream from the lens or combination of lenses. A multi-focus mirror has a focal length that varies depending on the position of the incident ray of light. The focus variation can be achieved by any mean, including varying the radius of curvature across the surface of the mirror.

Embodiments of the present invention provide introducing at least one incident laser beam; directing the incident laser beam toward a multiple focal mirror device, the multiple focal mirror device comprising at least a first reflective surface and a second reflective surface; splitting the incident laser beam into a plurality of partial laser beams; and directing the partial laser beams through a refractive lens, wherein the partial laser beams have a different plane of focus.

Embodiments of this invention provide a method and apparatus for laser processing using a laser beam for welding sheets using an optics set-up that create more than one focus point of extreme power density at the work piece. Such a laser process produces finished products having good integrity; can be used to laser cut materials at high power and high speed; can be used to laser cut metals as organics and wood compounds; can be used to weld sheets at high power and high speed; can be used to join coated sheets in any joint configuration including lap-joint, fillet-joint and butt-joint; and can be used with both autogenous and filler or powder metal welding applications.

According to one embodiment, the light condensing device, such as, for example, a standard focusing lens, may be upstream of said multiple focal mirror device. With the present invention, the multiple focal mirror device may be made from a copper based material or a silicone based material or any other material deemed appropriate for the particular type of industrial laser being used. With the present invention, the focal length of said multiple focal mirror device may be varied. With the present invention, this focal point variability may be performed by varying the radius of curvature across the surface of the multiple focal mirror device. With the present invention, all reflective surfaces of said multiple focus mirror device may be generally coplanar. With the present invention, the multiple focus mirror device may be absent of any half-mirror surfaces.

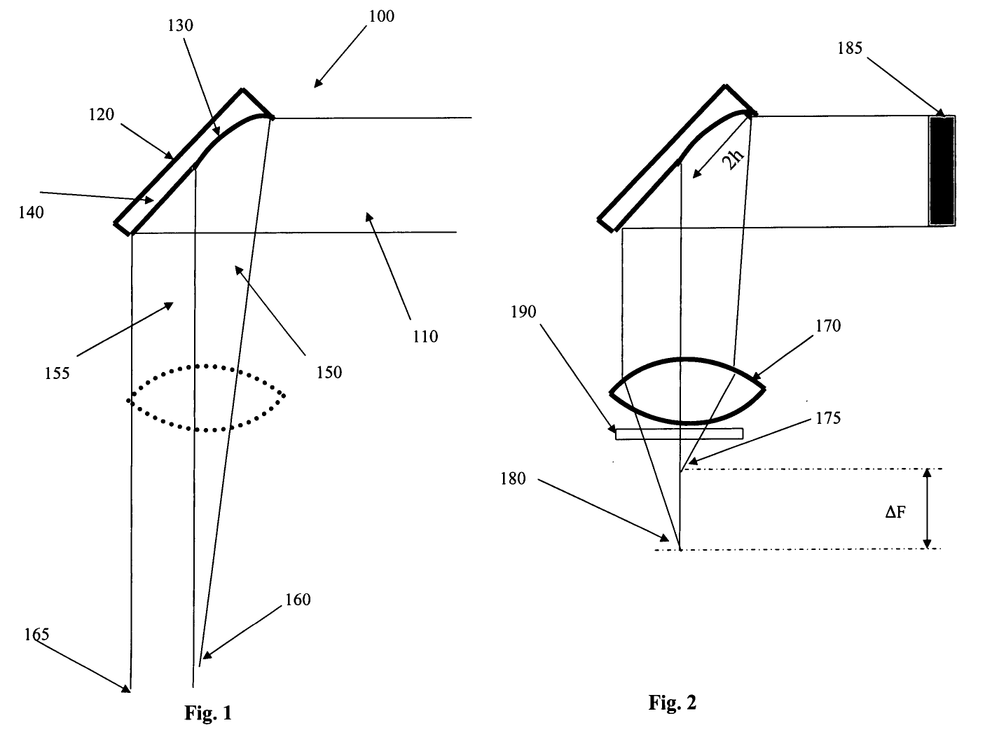

Turning now to FIG. 1 and FIG. 2, a method and apparatus for focusing a laser beam 100 in accordance with one embodiment of the present invention is illustrated. The apparatus for focusing a laser beam 100 comprises a multiple focal mirror device 120 and a light-condensing device 170. The multiple focal mirror device 120 comprises at least a first reflective surface 130 and a second reflective surface 140.

In one embodiment of focusing apparatus 100, the first reflective surface 130 is formed in a region of the multiple focal mirror device 120 that is adjacent to the region of the multiple focal mirror device 120 that forms second reflective surface 140. The overall shape of either the first reflective surface 130 or the second reflective surface 140 may be either planar, concave or convex.

In one embodiment, a laser generator 185 generates at least one incident laser beam 110, which is directed toward the multiple focal mirror device 120. The reflection of the incident laser beam 110 can then be decomposed into at least a first reflected laser beam 150, as the result of the optical qualities of the first reflective surface 130, and a second reflected laser beam 155, as the result of the optical qualities of the second reflective surface 140. In one embodiment, the optical qualities of the first reflective surface 130 and the optical qualities of the second reflective surface 140 are dissimilar, thereby resulting in two partial reflected laser beams 150, 155 with different focal points 160, 165.

The first reflected laser beam 150, if unaffected by any other optical means, would have a first focal point, 160. The second reflected laser beam 155, if unaffected by any other optical means, would have a second focal point, 165. Either focal point 160, 165 may be infinity.

In the illustrative embodiment, however, the first reflected laser beam 150 and the second reflected laser beam 155, are directed through light condensing device 170. The light condensing device 170 causes the first reflected laser beam 150 to be focused at focal point, 175, and the second reflected laser beam 155 to be focused at focal point, 180. At least one cutting nozzle 190 may be situated at a point intermediate to light condensing device 170 and the locus of 175 and 180. The cutting nozzle 190 may be used to provide shield gas or assist gas to the device, as would be known to one skilled in the art.

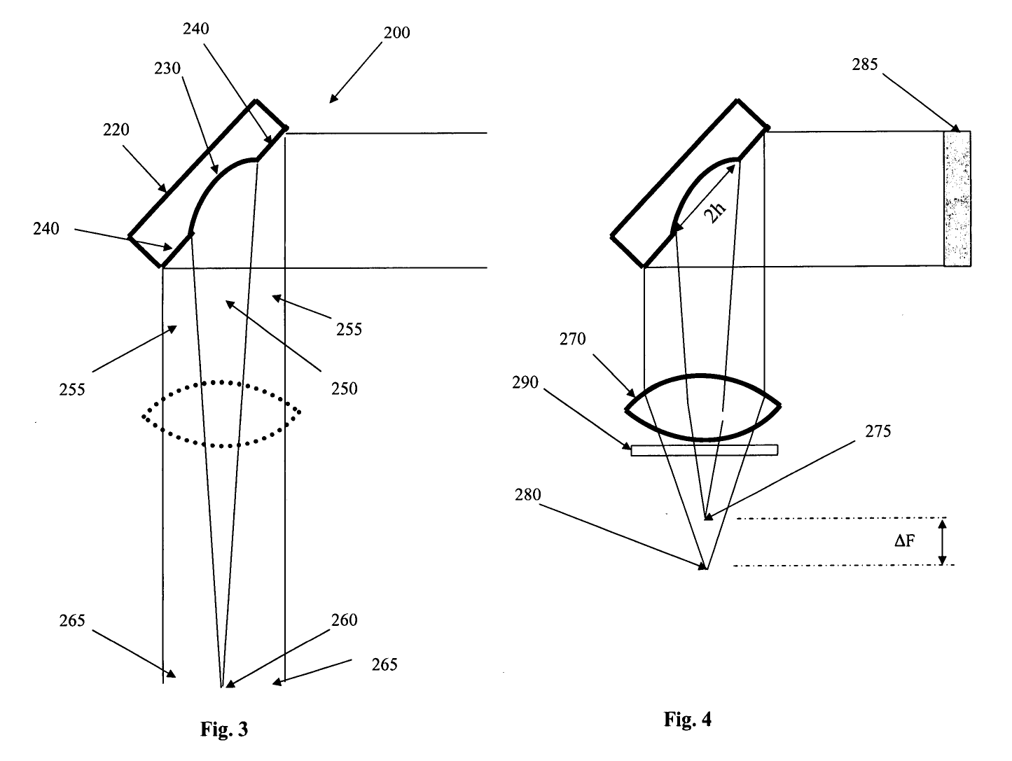

Turning now to FIG. 3 and FIG. 4, a method and apparatus for focusing a laser beam 200 in accordance with the embodiment of the present invention is illustrated. The method and apparatus for focusing a laser beam 200 comprises a multiple focal mirror device 220 and a light-condensing device 270. The multiple focal mirror device 220 comprises at least a first reflective surface 230 and a second reflective surface 240. The first reflective surface 230 may be in the central portion of the multiple focal mirror device 220, with the second reflective surface 240 forming the area surrounding the first reflective surface 230.

In one embodiment of focusing apparatus 200, the first reflective surface 230 is formed in a region of the multiple focal mirror device 220 that is adjacent to the region of the multiple focal mirror device 220 that forms second reflective surface 240. In one embodiment of the focusing apparatus 200, the first reflective surface 230 is formed in a region that is intermediate to two regions comprising the second reflective surface 240. The overall shape of either the first reflective surface 230 or the second reflective surface 240 may be either planar, concave or convex. The first reflective surface 230 may be concentric with the second reflective surface. 240

In one embodiment, a laser generator 285 generates at least one incident laser beam 210, which is directed toward the multiple focal mirror device 220. The reflection of the incident laser beam 210 can then be decomposed into at least a first reflected laser beam 250, based on the optical qualities of the first reflective surface 230, and a second reflected laser beam 255, based on the optical qualities of the second reflective surface 240. In one embodiment, the optical qualities of the first reflective surface 230 and the optical qualities of the second reflective surface 240 are dissimilar, thereby resulting in two partial reflected laser beams 250, 255 with different focal points 260, 265.

The first reflected beam 250 may be concentric with the second reflected beam 255. The first reflected beam 250 may be central to the second reflected beam 255, and the second reflected beam 255 may surround the first reflected beam 250. The first reflected laser beam 250, if unaffected by any other optical means, would have a first focal point, 260. The second reflected laser beam 255, if unaffected by any other optical means, would have a second focal point, 265. Either 260 or 265 may be infinity.

However, the first reflected laser beam 250 and the second reflected laser beam 255, are directed through light condensing device 270. This result in the first reflected laser beam 250 being focused at focal point, 275, and the second reflected laser beam 255 being focused at focal point, 280. At least one cutting nozzle 290 may be situated at a point intermediate to light condensing device 270 and the locus of 275 and 280. The cutting nozzle 290 may be used to provide shield gas or assist gas to the device, as would be known to one skilled in the art.

Although FIGS. 3 and 4 illustrate a dual focus mirror with a concave surface 230 and a flat surface 240, the present invention also encompasses all combinations of designs resulting in a multiple focus mirror, including designs where surface 230 may have a convex shape, whether spherical or non-spherical, and where surface 240 may not be flat.

In one embodiment, reflective surface 130, 230 may be spherical concave or convex with a radius of curvature of the order about 2 m to about 30 m, and preferably from about 4 m to about 20 m. In one embodiment, reflective surface 130, 230 is included in an area within a circle of diameter 2h (where “h” is the measured sagittal height of a lens) of the order of about 2 mm to about 12 mm.

In one embodiment, a multiple focus mirror of the present invention can be advantageously used to perform laser cutting, with one of the reflective surfaces being convex and an assist gas. In a particular application, an assist gas mixture containing at least about 20% nitrogen is used.

In another embodiment, a multiple focus mirror of the present invention can be advantageously used to perform laser cutting with one of said reflective surfaces being concave and in the presence of an assist gas consisting of oxygen. In another embodiment, a multiple focus mirror of the present invention can be advantageously used to perform laser welding, with any shield gas, and preferably with a shield gas consisting of any mixture containing at least about 20% nitrogen. In practice, this multiple focus mirror can be advantageously used to perform laser welding, with any shield gas, and preferably with a shield gas consisting of any mixture containing at least about 20% argon.

In another embodiment, a multiple focus mirror of the present invention can be advantageously used to perform laser welding, with said laser welding using a CO₂ laser and a shield gas selected from one of either pure helium or any mixture containing helium, the mixture being preferably at most about 80% helium. In another embodiment, this multiple focus mirror can be advantageously used to perform laser drilling, with one of said reflective surfaces being convex.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. An apparatus for focusing a laser beam comprising:
a) a multiple focal mirror device, comprising at least a first reflective surface and a second reflective surface, for reflecting an incident laser beam respectively from each of said reflective surfaces as a plurality of partial laser beams; and
b) a light condensing device positioned to receive the partial laser beams from said multiple focal mirror device, and configured to focus the partial laser beams according to the respective focal points of the partial laser beams, the focal points being different from each other.

2. The apparatus of claim 1, wherein said incident laser beam is generated by one or more laser sources selected from the group consisting of:
a) a CO₂ laser;
b) a YAG laser;
c) a fiber laser;
d) a diode laser; and
e) a disk laser.

3. The apparatus of claim 1, wherein one of said reflective surfaces is non-planar and has a maximum radius of curvature not exceeding about 30 m.

4. The apparatus of claim 1, wherein only one of said reflective surfaces is flat.

5. The apparatus of claim 1, wherein one of said reflective surfaces is included in an area within a circle of diameter 2h not exceeding about 15 mm.

6. The apparatus of claim 1, wherein said multiple focal mirror device is made from a copper based material or a silicone based material.

7. The apparatus of claim 1, wherein the focal length of said multiple focal mirror device can be varied.

8. The apparatus of claim 1, wherein all reflective surfaces of said multiple focus mirror device are generally coplanar.

9. The apparatus of claim 1, wherein said multiple focus mirror device is absent any half mirror surfaces.

10. A method for focusing a laser beam to accomplish a laser processing task, comprising:
a) providing at least one incident laser beam;
b) directing said incident laser beam toward a multiple focal mirror device, said multiple focal mirror device comprising at least a first reflective surface and a second reflective surface;
c) decomposing the reflection of said incident laser beam into at least a first reflected laser beam and a second reflected laser beam, wherein:
i) said first reflected laser beam is the result of the incident laser beam striking and reflecting off of said first reflective surface, and wherein said first reflected laser beam has a first point of focus;
ii) said second reflected laser beam is the result of the incident laser beam striking and reflecting off of said second reflective surface; and
iii) wherein said second reflected laser beam has a second point of focus, said first point of focus and said second point of focus having a different point of focus, different from the first point of focus.

11. The method of claim 10, wherein said incident laser beam is raw unfocused.

12. The method of claim 10, wherein said incident laser beam is pre-focused before impinging on said multiple focal mirror.

13. The method of claim 10, wherein said first reflected beam and said second reflected beam are directed through a refractive lens, wherein said first reflected laser beam has a third point of focus, said second reflected laser beam has a fourth point of focus, said third point of focus and said fourth point of focus having a different plain of focus.

14. The method of claim 10, wherein said focused laser beams are used to perform a task selected from the group consisting of:
a) laser cutting;
b) laser welding;
c) laser drilling;
d) laser brazing; and
e) laser surface treatment.

15. The method of claim 14, wherein said laser surface treatment is performed with the addition of powder, or with the addition of filler material.

16. The method of claim 14, wherein said laser surface treatment is performed without the addition of powder, or without the addition of filler material.

17. The method of claim 14, wherein said task is performed with any combination of shielding gas, or with any combination of assist gas.

18. The method If claim 14, wherein said task is performed without any shield gas or without any assist gas.

19. The method of claim 10, wherein said laser is selected from the group consisting of:
a) CO₂ laser;
b) YAG laser;
c) fiber laser;
d) diode laser; and
e) disk laser.

20. The method of claim 10, wherein said focused laser beam is directed toward a work piece and said laser beam's power exceeds 4 kW.

21. The method of claim 10, wherein one of said reflective surfaces is not flat and has a maximum radius of curvature not exceeding about 30 m.

22. The method of claim 10, wherein only one of said reflective surfaces is flat.

23. The method of claim 10, wherein one of said reflective surfaces is included in an area within a circle of diameter 2h not exceeding about 15 mm.

24. The method of claim 10, wherein said mirror device is made from a copper based material or a silicone based material.

25. The method of claim 10, wherein the focal length of said multiple focal mirror device is variable.

26. The method of claim 25, wherein said variability is performed by varying the radius of curvature across the surface of the multiple focal mirror device.

27. The method of claim 10, wherein said multiple focus mirror device comprises all reflective surfaces being generally coplanar.

28. The method of claim 10, wherein said multiple focus mirror device is absent any half mirror surfaces.

29. The method of claim 10, wherein the reflective surfaces are convex and further comprising:
a) flowing an assist gas consisting of a mixture containing at least 20% nitrogen; and
b) performing laser cutting with said focused laser beams in the presence of an assist gas.

30. The method of claim 10, wherein the reflective surfaces are convex and further comprising:
a) flowing a shield gas used consisting of any mixture containing at least 20% nitrogen; and
b) performing laser cutting with said focused laser beams in the presence of a shield gas.

31. The method of claim 10, wherein the reflective surfaces are convex and further comprising:
a) flowing an assist gas consisting of a mixture containing at least 20% argon; and
b) performing laser cutting with said focused laser beams in the presence of an assist gas.

32. The method of claim 10, wherein the reflective surfaces are convex and further comprising:
a) flowing an assist gas consisting of a mixture containing at least 80% helium, wherein said laser comprises a CO₂ laser; and
b) performing laser cutting with said focused laser beams in the presence of an assist gas.

33. The method of claim 10, wherein the reflective surfaces are convex and further comprising performing laser drilling with said focused laser beams.

34. The method of claim 10, wherein the reflective surfaces are concave and further comprising:
a) flowing an assist gas consisting of a mixture containing oxygen; and
b) performing laser cutting with said focused laser beams in the presence of an assist gas.

35. The method of claim 10 further comprising:
a) flowing a shield gas consisting of a mixture containing at least 20% nitrogen; and
b) performing laser cutting with said focused laser beams in the presence of a shield gas.

36. The method of claim 10 further comprising:
a) flowing a shield gas consisting of a mixture containing at least 20% argon; and
b) performing laser cutting with said focused laser beams in the presence of a shield gas.
